(19) United States
(12) Patent Application Publication
(10) Pub. No.: US 2026/0273443 A1
(43) Pub. Date: Sep. 17, 2026

(54) Filter Apparatus

(71) Applicant: HYDAC Filter Systems GmbH, Sulzbach / Saar (DE)

(72) Inventor: Thorsten Falk, Saarbrücken (DE)

(73) Assignee: HYDAC Filter Systems GmbH, Sulzbach / Saar (DE)

(21) Appl. No.: 19/135,734

(22) PCT Filed: May 27, 2024
(86) PCT No.: PCT/EP2024/064497

§ 371 Date: Jun. 4, 2025

(30) Foreign Application Priority Data
Jul. 20, 2023 (DE) 10 2023 002 969.6

(51) Int. Cl. B01D 35/30; B01D 46/00

(52) U.S. Cl. CPC B01D 35/301; B01D 46/0004; B01D 2201/301; B01D 2201/4015; B01D 2265/022

(57) ABSTRACT

Disclosed is a filter apparatus with a filter housing comprising at least two housing parts, which can be connected re-releasably to one another by means of a connecting device. The connecting device, designed in the form of a bayonet closure, has individual closure elements on the one housing part, and those are spaced apart from one another such that further closure 70 elements of the other housing part engage at least in part into the spacings, wherein relative movement of the two housing parts causes the closure elements of one housing part and the other housing part to be brought into engagement with one another, or separated from one another, at least in part.

### CROSS-REFERENCE TO RELATED APPLICATIONS

This application claims priority to German Patent Application DE 10 2023 002 969.6, filed on Jul. 20, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter apparatus with a filter housing comprising at least two housing parts which can be connected re-releasably to one another by means of a connecting device.

EP 1 088 581 B1 discloses a filter apparatus with at least two filtration chambers, each of which is received in an element holder and comprises a filter element and a changeover unit for optionally connecting and separating the filtration chambers in a fluid-conveying manner, the components of the filtration chambers and the changeover unit being assembled by means of screw connections.

In particular, a housing cover on the top side is connected in a re-releasable manner to the assignable filtration chamber for receiving the filter element via a screw connection. The connecting device formed of individual screws requires a certain degree of care when screwing the screws in and out and the full number of individual screws is necessary for a secure, sealed connection between the housing cover and the filtration chamber. Missing screws must always be replaced first before operating the known filter apparatus for the first time.

WO 99/61131 A1 discloses an apparatus for detachably connecting a hollow cylindrical filter element to a filtering device having a flange part serving as filter holder, the edge of an end-side opening of the filter element being able to be pressed onto the annular surface of said flange part by means of a clamping device, providing mutual sealing, which has clips with resilient legs provided on the flange part which can be latched with at least one latching element formed on the filter element, the clamping device having a plurality of spring clips configured as separate components which are arranged distributed around the circumference of the flange part. In this manner, a filter head as one housing part of a filter apparatus can be simply connected to a filter element in a re-releasable manner; however, it does not provide for the filter head to be connected to further housing parts of a filter apparatus, such as, for example, a cup-shaped housing receptacle, for exchangeably receiving a filter element.

EP 1 263 518 B1 discloses a filter apparatus comprising at least one filter element, which can be accommodated inside a filter housing, having an inlet for a fluid to be cleaned and an outlet for the fluid cleaned by the filter element, the filter element being retained in at least one element holder of the filter housing by using a bayonet closure. Furthermore, a housing cover can be re-releasably connected to the housing receptacle by means of a clamping band which can be actuated by hand using a clamping strap. The corresponding quick-band closure with the clamping strap also needs to be supplied and handled separately, in addition to the housing parts of the filter apparatus, clamping the band requiring a great deal of force.

### SUMMARY

A need exists to provide an improved filter apparatus. The need is addressed by the subject matter of the independent claim(s). Embodiments of the invention are described in the dependent claims, the following description, and the drawings.

### BRIEF DESCRIPTION OF THE DRAWINGS

FIG. 1 shows a perspective view of an example filter apparatus in its entirety;

FIGS. 2 to 5 show different views of an example cover closure with a bayonet as shown in FIG. 1;

FIGS. 6 and 7 show an example locking device for the housing cover according to FIG. 1 to 5, in one case in the locked state and in the other case in the open state.

### DESCRIPTION

The details of one or more embodiments are set forth in the accompanying drawing and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the connecting device, designed in the form of a bayonet closure, has individual closure elements on one housing part, and these individual closure elements are spaced apart from one another such that further closure elements of the other housing part engage at least in part in the spacings, and in that a relative movement of the two housing parts causes the closure elements of one housing part and the other housing part to be brought into engagement with one another, or separated from one another, at least in part, the bayonet closure is an integral component of the housing parts and thus of the filter housing with the result that additional parts, such as screws or a clamping band device, are not necessary to produce the required connection between the housing parts of the filter housing in a re-releasable manner.

The bayonet closure is also functionally reliable and self-explanatory in terms of handling, with the result that even assembly staff with no special training can establish and then re-release the connection. The bayonet closure is low-maintenance and wear-free, with the result that the aforementioned housing parts can be separated from one another even over a long usage period, which is generally required if a filter element stored in the filter housing clogged by particulate contamination needs to be replaced with a new element. When the used filter element has been removed, a new element can then also be reinserted in its place and the housing parts can then be connected to one another in the reverse sequence as the preceding separation operation, with the result that assembly times and associated assembly costs can be reduced.

In the case of a relative movement of the two housing parts, this means that one housing part is generally regarded as fixed and the other housing part is accordingly moved relative to this housing part for a release or fixing operation. However, if necessary, the other housing part may also be fixed and the first housing part moves relative thereto. Furthermore, it is possible to move both housing parts equally relative to one another for an opening or closing operation, as long as the use of the filter apparatus allows this.

In some embodiments of the filter apparatus, it is provided that one set of closure elements are formed by closure hooks, at least one assignable engagement part laterally entering or leaving the respective hook opening thereof during the relative movement as the respective further closure element for a connecting or releasing operation. In this manner, high connecting forces can be created between the two housing parts such that the connecting device according to the teachings herein is also suitable for high-pressure applications.

In some embodiments of the filter apparatus, a locking device is provided which holds the bayonet closure in its closed position in the locked state and releases said bayonet closure for an opening operation in the opened state. For example, in this case, it is provided that the locking device has at least one handle, which, when released, for example by means of a safety device, is able to move from a locking position into a released position, and vice versa, and in that, in the locking position, the respective handle engages between the spacing between two adjacent closure elements and as such blocks the relative movement of the two housing parts. In this manner, this provides double security, especially when separating the two housing parts from one another, with the result that operating errors can be ruled out under all circumstances. After releasing the handle by means of the safety device, when the corresponding handle is actuated, it controls the valve device, which can be moved in the direction of its released position to create a fluid path from the inside of the filter housing to the environment and block it again in the locking position. In this manner, any excess pressure in the filter housing, particularly in the form of trapped air, automatically escapes into the environment when the connecting device is unlocked, with the result that, when the housing part connection is released, under no circumstances is one housing part forced apart from the other housing part due to pressure, which could have an adverse effect on operating safety.

In some embodiments of the filter apparatus, it is provided that one housing part, which has one set of closure elements, is configured as a housing receptacle and serves to receive a for example interchangeable filter element, and in that the other housing part, which has the further closure elements, forms a housing cover for closing the housing receptacle so that it can be opened again. In this manner, the housing receptacle remains stationary in one installation location, generally along with the associated pipework, via which the unfiltered medium flows into the filter apparatus and by means of which the filtrate cleaned by means of the filter element flows out of the apparatus so as to supply a hydraulic supply circuit with cleaned fluid in this manner, the filter apparatus being connected to said supply circuit in the conventional manner. Accordingly, only one housing cover with the handles and some of the closure elements needs to be handled for the bayonet closure to be created, which brings about a considerable reduction in weight and simplifies the handling operations.

In some embodiments of the filter apparatus, it is provided that closure hooks, for example in pairs, lying diametrically opposite one another in relation to the longitudinal axis of the filter housing, and arranged on the outer circumferential side in the edge region of the housing receptacle, protrude with their hook openings over the opening of the housing receptacle that can be released by means of the housing cover. In this manner, when the bayonet closure has been established, a uniform application of force between the housing receptacle and the housing cover is achieved during operation of the filter apparatus.

In this process, the engagement parts are for example formed by engagement webs on the housing cover, which protrude in a ring-like manner on the outer circumference of the housing cover, and their respective length, viewed in the relative direction of rotation, is smaller than the spacing between two adjacent closure hooks. Due to the aforementioned embodiment, the bayonet connection can be created and released in a virtually self-explanatory manner.

In some embodiments of the filter apparatus, it is provided that the respective handle consists of a gripping bar, and that two of these gripping bars, lying diametrically opposite one another in relation to the longitudinal axis of the filter housing, are in each case pivotably mounted on the housing cover by means of a pivot bearing and, in their locking position, extend over the free cover edge and the opening of the housing receptacle in the direction of their other free end by a pre-definable distance. In this manner, the respective handles in the form of gripping bars are arranged on the filter housing in a space-saving manner, ensuring that the handles cannot be operated inadvertently. In this manner, this also ensures a substantially symmetrical structure for the filter apparatus with its filter housing in its entirety, with the result that this can be accommodated in any installation positions on site. It is also possible to stand the filter apparatus vertically on a frame of a transport truck with the result that the filter apparatus in its entirety can be freely displaced via the corresponding transport truck and in particular can be moved to areas of mechanical equipment with operating fluid that also requires cleaning.

In some embodiments of the filter apparatus, it is provided that at least one blocking element is present on a gripping bar to prevent unintentional opening of the bayonet closure in the locking position of the respective handle. Due to the blocking element, unintentional rotation of the housing parts in relation to one another for the purpose of releasing the bayonet enclosure is safely prevented as long as the handle of the locking device is kept in its locking position.

The filter apparatus is discussed in greater detail below with reference to further embodiments according to the FIGS. The FIGS. are schematic and not necessarily to scale.

Specific references to components, process steps, and other elements are not intended to be limiting. Further, it is understood that like parts bear the same or similar reference numerals when referring to alternate FIGS.

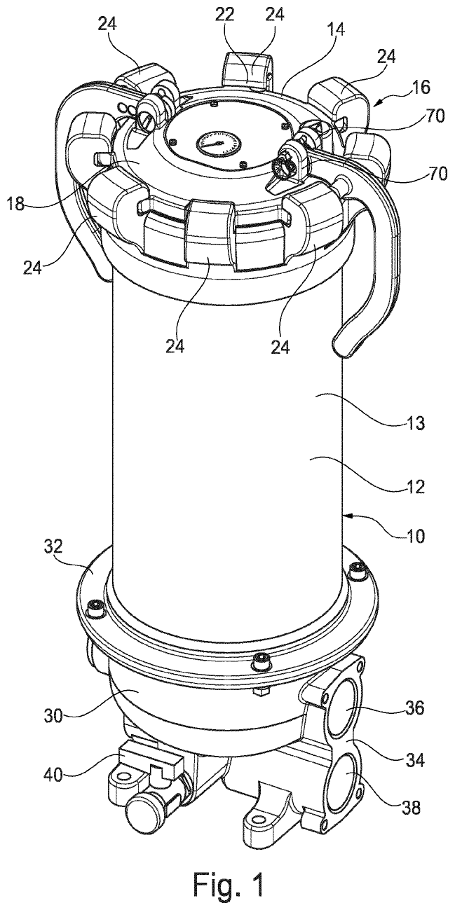

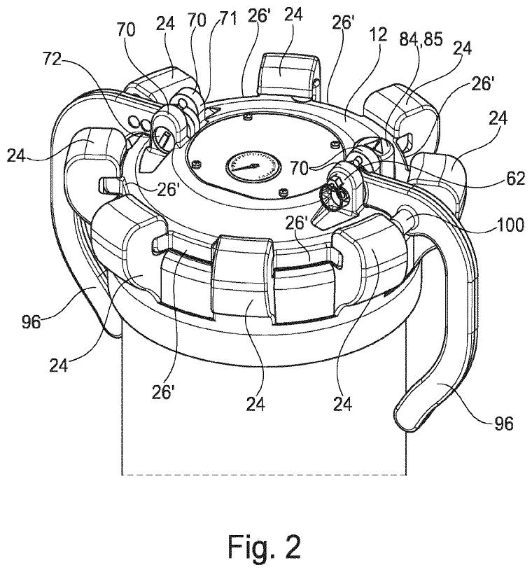

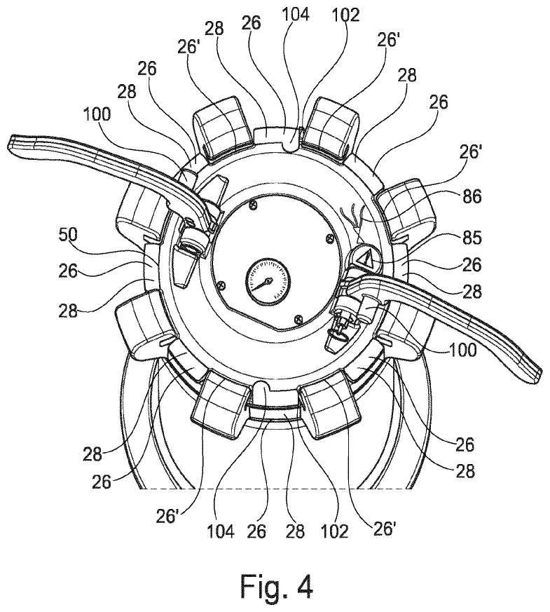

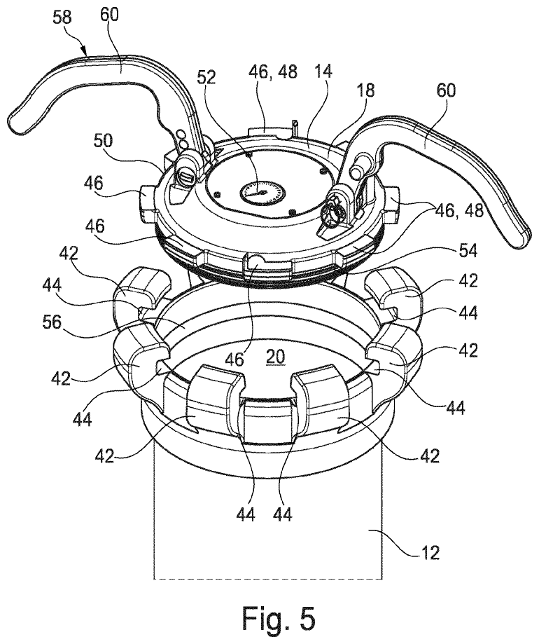

The filter apparatus according to FIG. 1 has, in its entirety, a filter housing referred to as 10, which substantially comprises two housing parts 12, 14, which are re-releasably connected to one another in their entirety by means of a connecting device 16. The first housing part 12 consists of a cylindrical housing receptacle 13 for an interchangeable filter element, which is not shown in further detail. The second housing part 14 is in turn configured in the form of a housing cover 18, which closes an upper, substantially circular opening 20 in the first housing part 12 or the housing receptacle 13 (FIG. 5) respectively. As is shown particularly clearly in FIG. 1 to 5, the connecting device 16 is configured as a bayonet closure 22. The bayonet closure 22 has individual closure elements 24 on one housing part 12; a total of eight items in this particular embodiment (FIG. 2). The individual closure elements 24 are spaced apart from one another along a notional circular ring such that further closure elements 28 of the other housing part or second housing part 14 respectively in the form of the housing cover 18 are able to engage in the individual spacings 26 in a second step, which is shown in particular in the drawing reproduced in FIG. 4, which shows a partial disconnection of the housing cover 18 from the housing receptacle 13. Similarly, there are also eight spacings 26′ and eight further closure elements 28 on the housing cover 18.

The first housing part 12 in the form of the housing receptacle 13 for the filter element is received at the foot or bottom side in a closure pot 30 or opens out into said closure pot, the connection between the first housing part 12 and the closure pot 30 being created via a weld joint. Furthermore, a flanged connection 32 is provided, protruding over the jacket of the housing part 12 on the outer circumferential side and serving to fix the entire filter housing in a mounting plate (not shown) with the illustrated screws. The closure pot 30 has an inlet 36 for unfiltered medium and an outlet 38 for filtrate as part of a flange connector 34. In this process, the unfiltered medium in the inside 68 of the filter housing 10 passes through the filter element (not shown) from the outside to the inside, and the filtrate, which is located on the inside of the filter element and is cleaned of particulate contamination, leaves the filter apparatus via the outlet 38. Accordingly, both the inlet 36 and the outlet 38 can be connected by using a further flanged connection with the flange connector 34 to standard pipework for a hydraulic supply circuit or similar.

At the lowest point, the closure pot 30 has a manually actuatable drain valve 40, which, when the filter apparatus is not operational, in its opened state allows fluid to drain to the outside from the inside 68 of the filter housing 10. It is necessary to empty the filter housing 10 accordingly so that it is possible to replace the element, as described in further detail below, during which operation the housing cover 18 is removed and refitted, manifestly using the bayonet closure 22.

As is also shown in FIG. 5, one set of closure elements 24 are formed by closure hooks 42, at least one assignable engagement part 46 laterally entering or leaving the respective hook opening 44 thereof as the respective further closure element 28 for a connecting or releasing operation. The respective hook opening 44 is incorporated in the closure hook 42 as a slot-shaped groove and all hook openings 44 open in the direction of the opening 20 of the housing receptacle 13 and laterally on the delimiting walls, which are opposite one another, of the hooks 42. Furthermore, all hook openings 44 lie in a closure plane parallel to the plane spanning the opening 20 on the free edge of the housing receptacle 13. All closure hooks 42 with their hook openings 44 are configured to be geometrically identical, as are the engagement parts 46 which are configured in the form of cam-like engagement webs 48. Each engagement part 46 or each engagement web 48 respectively is in each case configured such that, in a hooking engagement from beneath, these are able to engage in the hook openings 44 of each closure hook 42 in a locking manner, as is shown in further detail in FIG. 2 by way of example. The engagement parts 46 extend outwards in a ring-like manner from the centre of the housing cover 18 and protrude over the cover edge 50 by a pre-definable overhang. The engagement parts 46, viewed in the radial circumferential direction of the housing cover 18, have an identical spacing 26′ from one another, which is measured such that the closure hooks 42 are able to engage with their free end face in the correspondingly formed spacings 26′ between the engagement parts 46. Similarly, the spacings 26 between the closure hooks 42 are in each case furnished with a free width such that the engagement parts 46 can be inserted into these spacings 26 from above.

Accordingly, the individual closure hooks 42, for example in pairs, lying diametrically opposite one another in relation to the longitudinal axis of the filter housing 10, are arranged on the outer circumferential side in the edge region of the housing receptacle 13 with the free opening 20. Furthermore, the closure hooks 42 with their hook openings 44 protrude over the opening 20 of the housing receptacle 13 that can be released by means of the housing cover 18 by a pre-definable axial spacing. A comparable arrangement, in pairs diametrically opposite one another in relation to the longitudinal axis of the housing cover 18, is also provided for the engagement webs 48. A high-strength connection between the housing cover 18 and the housing receptacle 13 is achieved if eight closure hooks 42 interact with eight engagement webs 48 as part of the closed bayonet closure 22 as in the embodiment shown. However, a larger or smaller number of closure hooks 42 and engagement webs 48 may also be provided, for example only four of each, which, however, for uniform force application, should once again for example be arranged in pairs, diametrically opposite one another on the housing receptacle 13 or on the housing cover 18. Thus, in principle, the closure hooks 42 could also be accommodated on the housing cover 18 and the engagement webs 48 on the housing receptacle 13. Otherwise, the number of individual closure elements 24, 28 is dependent on the size of the container opening 20. In this case, the general rule is the larger the diameter of the filter apparatus with its housing 10, the greater the number of closure elements 24, 28 used.

The housing cover 18 is configured as a flat disc and has a conventional manometer display 52 on its top side, by means of which the operating pressure in the inside 68 of the filter housing 10 can be indicated for an onlooker. In the direction of its opposite underside, the housing cover 18 has a circumferential annular seal 54, which provides effective sealing as soon as the bayonet closure 22 is established so as to thus seal the inside 68 of the housing receptacle 13 from the environment. For corresponding sealing purposes, the annular seal 54 may for example undergo pre-tensioning as soon as the engagement webs 48 engage in the hook openings 44 of the individual closure hooks 42 from beneath. For a corresponding feed motion of the annular seal 54 onto a sealing surface arranged opposite, it may also be provided that the engagement webs 48 are furnished with a slight inclination or pitch. In addition or alternatively, the housing cover 18 may also be fed manually to apply a contact force on the annular seal 54 opposite the sealing face such that said annular seal comes into contact with the sealing face while pre-tensioned. Furthermore, a circumferential shoulder 56, offset axially backwards, which protrudes inwards, is provided on the inside of the housing receptacle 13.

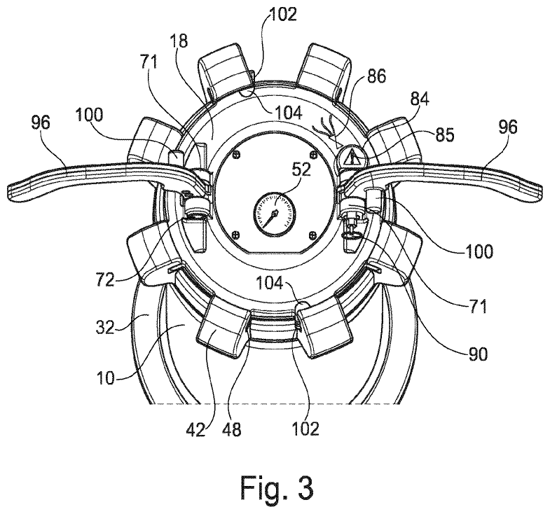

To create a corresponding seal, a locking device 58 is provided in its entirety, which, in the locked state as shown in FIGS. 1 and 2, holds the bayonet closure 22 in its closed position and, in the open state as shown in FIGS. 3 to 5, releases said bayonet closure for an opening operation. In this case, the locking device 58 has two handles 60, one of which, when released by means of a safety device 62, is able to move or pivot, respectively, from a locking position into a released position, and vice versa, wherein, in the locking position as shown in FIGS. 1 and 2, the respective handle 60 engages between the spacing 26, 26′ between two adjacent closure elements 24, 28 and as such blocks a potential relative movement of the two housing parts 12, 14.

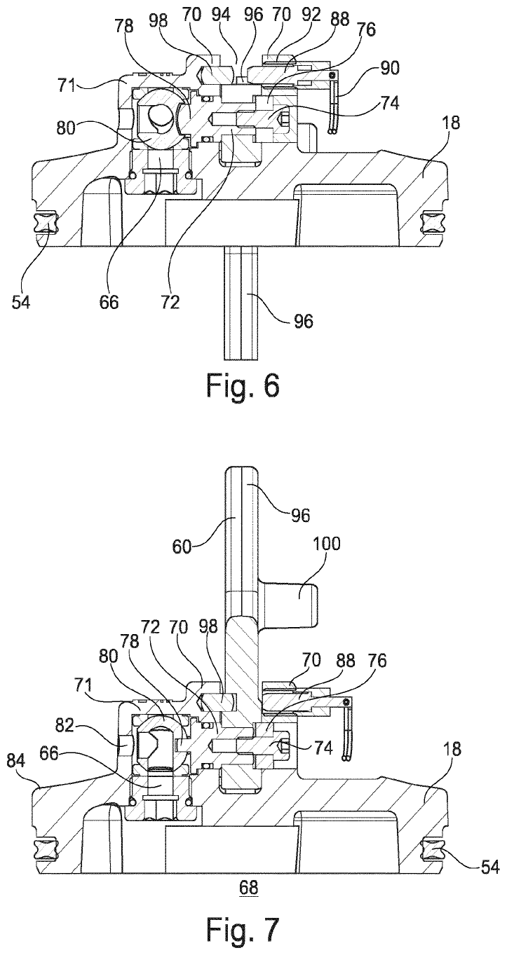

The right-hand handle 60 as viewed on FIGS. 1 to 5, which exclusively interacts directly with the safety device 62, controls a valve device 64, which, by the handle 60, in the direction of its released position shown in FIG. 7, originating from the locked position shown in FIG. 6, establishes a fluid path 66 from the inside 68 of the filter housing 10 into the environment and blocks said fluid path in the locking position shown in FIG. 6. To this end, the housing cover 18, at the edges on its top side, has two semi-annular holders 70 connected integrally with said cover and protruding over the top side as part of a bearing housing 71, which is penetrated by a pivot pin 72, which is firmly connected with one of its free ends via a screw connection 74 and via an annular carrier element 76 to one free end of the handle 60, which is adjacent to the housing cover 18, and the other free end of the pivot pin 72 opens via a pin connection 78 into a valve ball 80 of a ball valve or ball cock as the valve device 64, the corresponding valve ball 80 also being referred to in technical jargon as a ‘cock’. In FIG. 7, the valve ball 80 is shown in an actuating position which releases the fluid path 66 from the inside 68 to the environment via a vent opening 82 in the bearing housing 71 for the pivot pin 72. The corresponding vent opening 82 opens adjacent to an underlying shoulder 84 of the bearing housing 71, which is furnished with a warning or caution symbol 85 to inform a fitter or operator that this might potentially be a hazardous area. Furthermore, a flow symbol with a picture of a valve 86 may be provided on the top side of the cover, which informs an expert, at least, that an actuatable valve device 64 must be provided in this region with the bearing housing 71 which, when actuated accordingly, may cause fluid to flow from the vent opening 82, generally in the form of a housing hole, and may theoretically lead to a hazardous situation, to which the warning or caution symbol 85 is intended to refer. However, as a rule, actuating the valve device 64 leads to a slow reduction in pressure, which means that in reality a hazard should not arise in practical handling operations.

The aforementioned safety device 62 has a spring-loaded safety pin 88 as shown in FIGS. 6 and 7, which is guided in a longitudinally displaceable manner in the bearing housing 71. The safety pin 88 has a finger lug 90 on its free end, with which it can be moved from its locking position shown in FIG. 6 into its released position, as shown in FIG. 7, against the action of the compression spring 92. As soon as the safety pin 88 is drawn back by hand and releases the engagement space 94 between the two holders 70, the handle 60 in the form of a gripping bar 96, as shown on the right in FIGS. 1 to 5, can be pivoted from its locking position shown in FIGS. 1 and 2 anticlockwise and upwards around the pivot pin 72 to assume the position shown in FIG. 7. In this process, the retracted end of the safety pin 88 comes into end-face contact with a side wall surface of the gripping bar 96.

On the opposite side to the movable safety pin 88, there is a pin-shaped stop 98 in the associated holder 70, which prevents the adjacent gripping bar 96 being inadvertently pivoted further beyond its pivot position shown in FIGS. 3 to 5. The gripping bar 96 which is articulated on one of its free ends on the pivot pin 72 and which surrounds the pin 72, in this case carries the valve ball 80 along with it via the pin 72 and the aforementioned pin connection 78 such that said ball moves from its position blocking the fluid path 66 in the bearing housing 71, as shown in FIG. 6, successively into the opened position shown in FIG. 7 and the fluid path 66 is released. In this manner, a potential excess pressure, particularly in the form of trapped air, located in the filter housing 10 can be automatically discharged into the environment when unlocking. In the reverse order, by pivoting the gripping bar 96 into its locking position shown in FIGS. 1 and 2, the valve device 64 can also be closed again.

The opposite left-hand gripping bar 96 has a comparable pivot mechanism, as described, but without a safety device 62 and without a valve device 64. In any event, the corresponding left-hand gripping bar 96 should in each case be pivoted in the opposite direction to the first gripping bar 96, in other words, for an opening operation as shown in the figures in the clockwise direction, and for a closing operation in the opposite, anticlockwise direction.

An opening operation for the accordingly closed bayonet closure 22 is now described in more detail below based on FIG. 1.

In a first step, the filter apparatus in its entirety is shut down and any fluid located in the filter housing 10 is discharged from the apparatus via the drain valve 40. When opening the drain valve 40, only some of the fluid flows out of the housing, however the excess pressure is dissipated completely. The safety pin 88 of the safety device 62 is then pulled and the right-hand handle 60 or gripping bar 98 respectively is pivoted upwards, whereupon the remaining fluid drains off by opening the valve device 64 and air enters the filter housing. If the drain valve 40 is not opened, the pressure is dissipated by actuating the valve device 64. The current pressure situation in the filter housing 10 can in each case be monitored accordingly via the manometer display 52 in the housing cover 18.

The two gripping bars 96 have cam-shaped blocking elements 100, which, in the locking position, prevent the relative movement of the housing cover 18 in a clockwise direction in relation to the housing receptacle 13, with the result that the housing cover 18 cannot be removed inadvertently, for example if the inside 68 of the filter housing 10 is still under a correspondingly high fluid pressure. As soon as venting by means of the valve device 64 is initiated by using the right-hand gripping bar 96, the left-hand gripping bar 96 can be actuated accordingly and pivoted into its released position. Also in this manner, a pivot bearing with a pin 72 mounted pivotably in a bearing housing 71 acts in the same way for the left-hand gripping bar 96 as in the first gripping bar solution.

If both gripping bars 96 are raised as shown in FIG. 3, the housing cover 18 is turned in the clockwise direction while the filter housing 10 remain stationary and the housing cover 18 then assumes its position as shown in FIG. 4. In the corresponding relative movement, the housing cover 18 carries with it its engagement webs 48, which are arranged securely thereon, which then pass into the individual spacings 26 between the closure hooks 42, and the hooks 42 then lie inside the spacings 26′ between the engagement webs 48. Protruding stops 102 are provided on two engagement webs 48 lying in pairs diametrically opposite one another, said stops, in the initial position shown in FIG. 3, in which the engagement webs 48 are still in engagement with the hook openings 44, abutting against the side of the adjacent closure hook 42, which receives the respective assignable engagement web 48 and, after the housing cover 18 is turned clockwise from its released position shown in FIG. 3 into the position shown in FIG. 4, the respective stop 102, together with the assigned engagement web 48, also pivots clockwise and then abuts the opposite closure hook 42. In the corresponding stop position shown in FIG. 4, which can be monitored from outside by an optical marking 104, the housing cover 18, as shown in FIG. 5, can be removed, generally in order to carry out a filter element replacement. Thus, as shown in FIG. 3, the optical marking 104 is still covered by parts of a closure hook 42 in the region of its hook opening 44 in the closed scenario, whereas in the released position shown in FIG. 4, the semicircular marking 104 can be observed in its entirety and shows that the bayonet closure 22 has now been opened.

After replacing the filter element, the filter apparatus can then be closed again, specifically in the reverse order, i.e. the housing cover 18 is first moved into its fixing position as shown in FIG. 5 and then placed on the housing receptacle 13 as shown in FIG. 4. As the individual spacings 26 are distributed along the 360° circumference of the housing receptacle 13, a circumferential angle of 45° arises in each case between adjacent engagement webs 48 and an adjacent closure hook 42, with the result that, when the housing cover 18 is placed in position and turned anticlockwise through 22.5° by means of the two handles 60, the two stops 102 pass from the further initial position shown in FIG. 4 back into their original stop position shown in FIG. 3. As such, the stops 102, only one of which may also suffice, indicate that the individual engagement webs 48 have come into latching engagement with the adjacent hook openings 44 of the assigned closure hooks 42, with the result that the bayonet closure 22 is closed once again.

The two gripping bars 96 are then pivoted downwards, this time starting from their upper stop position shown in FIG. 3, into their locking position shown in FIGS. 1 and 2, with the result that the safety device 62, starting from the position shown in FIG. 7, once again assumes its locked position shown in FIG. 6 and as such the free displacement movement of the associated handle 60 or gripping bar 96, respectively, is again blocked and, furthermore, the valve ball 80 of the valve device 64 is once again moved into its position blocking the fluid path 66. For example, the corresponding closing operation for the right-hand gripping bar 96 is only carried out when starting the filter apparatus up again when fluid emerges from the filter housing 10 via the valve device 64 and the vent opening 82 as part of venting; only then is the left-hand gripping bar for example moved into its position shown in FIGS. 1 and 2 and locking of the bayonet closure 22 is completed. The associated blocking elements 100 on the respective gripping bar 96 then slide laterally on the adjacent side of a closure hook 42 and in this manner secure locking by means of the bayonet closure 22.

In any event, the filter housing 10 is then accordingly secured in this manner against unintentional opening. Both opening and closing of the filter housing 10 via the handles 60 can be carried out with minimal actuating forces if required. The filter apparatus shown in FIG. 1 Is also designed to be extremely space-saving and also lightweight, with the result that the filter apparatus can also be used on shuttle or transport trucks to enable filtration to be carried out in a mobile manner on site at various machine installation locations if required.

What is claimed is:

1-10. (canceled)

11. A filter apparatus with a filter housing comprising at least two housing parts, which can be connected re-releasably to one another using a connecting device, wherein the connecting device, configured in the form of a bayonet closure, has individual closure elements on one housing part, and the individual closure elements are spaced apart from one another such that further closure elements of the other housing part engage at least in part in the spacings, and wherein a relative movement of the two housing parts causes the closure elements of one housing part and the other housing part to be brought into engagement with one another, or separated from one another, at least in part.

12. The filter apparatus of claim 11, wherein one set of closure elements are formed by closure hooks, at least one assignable engagement part laterally entering or leaving the respective hook opening thereof as the respective further closure element for a connecting or releasing operation.

13. The filter apparatus of claim 11, wherein a locking device is provided which holds the bayonet closure in its closed position in the locked state and releases said bayonet closure for an opening operation in the opened state.

14. The filter apparatus of claim 11, wherein the locking device has at least one handle, which, when released, is able to move from a locking position into a released position, and vice versa, and wherein, in the locking position, the respective handle engages between the spacing between two adjacent closure elements and as such blocks the relative movement of the two housing parts.

15. The filter apparatus of claim 11, wherein at least one handle controls a valve device, which can be actuated by this handle in the direction of its released position to create a fluid path from the inside of the filter housing to the environment and blocks it in the locking position.

16. The filter apparatus of claim 11, wherein one housing part, which has one set of closure elements, is configured as a housing receptacle and serves to receive a filter element, and wherein the other housing part, which has the further closure elements, forms a housing cover for closing the housing receptacle so that it can be opened again.

17. The filter apparatus of claim 11, wherein the closure hooks are arranged diametrically opposite one another in relation to the longitudinal axis of the filter housing, and arranged on the outer circumferential side in the edge region of the housing receptacle, protrude with their hook openings over the opening of the housing receptacle that can be released by the housing cover.

18. The filter apparatus of claim 11, wherein the engagement parts are formed by engagement webs on the housing cover, which protrude in a ring-like manner on the outer circumference of the housing cover, and their respective length, viewed in the direction of rotation, is smaller than the spacing between two adjacent closure hooks.

19. The filter apparatus of claim 11, wherein the respective handle consists of a gripping bar, and wherein two of these gripping bars, lying diametrically opposite one another in relation to the longitudinal axis of the filter housing, are in each case pivotably mounted on the housing cover by means of a pivot bearing and, in their locking position, extend over the free cover edge and the opening of the housing receptacle in the direction of their other free end by a pre-definable distance.

20. The filter apparatus of claim 11, wherein at least one blocking element is present on a gripping bar such as to prevent unintentional opening of the bayonet closure in the locking position of the respective handle.

21. The filter apparatus of claim 12, wherein a locking device is provided which holds the bayonet closure in its closed position in the locked state and releases said bayonet closure for an opening operation in the opened state.

22. The filter apparatus of claim 11, wherein the locking device has at least one handle, which, when released using a safety device, is able to move from a locking position into a released position, and vice versa, and wherein, in the locking position, the respective handle engages between the spacing between two adjacent closure elements and as such blocks the relative movement of the two housing parts.

23. The filter apparatus of claim 12, wherein the locking device has at least one handle, which, when released, is able to move from a locking position into a released position, and vice versa, and wherein, in the locking position, the respective handle engages between the spacing between two adjacent closure elements and as such blocks the relative movement of the two housing parts.

24. The filter apparatus of claim 13, wherein the locking device has at least one handle, which, when released, is able to move from a locking position into a released position, and vice versa, and wherein, in the locking position, the respective handle engages between the spacing between two adjacent closure elements and as such blocks the relative movement of the two housing parts.

25. The filter apparatus of claim 12, wherein at least one handle controls a valve device, which can be actuated by this handle in the direction of its released position to create a fluid path from the inside of the filter housing to the environment and blocks it in the locking position.

26. The filter apparatus of claim 13, wherein at least one handle controls a valve device, which can be actuated by this handle in the direction of its released position to create a fluid path from the inside of the filter housing to the environment and blocks it in the locking position.

27. The filter apparatus of claim 14, wherein at least one handle controls a valve device, which can be actuated by this handle in the direction of its released position to create a fluid path from the inside of the filter housing to the environment and blocks it in the locking position.

28. The filter apparatus of claim 11, wherein one housing part, which has one set of closure elements, is configured as a housing receptacle and serves to receive an interchangeable filter element, and wherein the other housing part, which has the further closure elements, forms a housing cover for closing the housing receptacle so that it can be opened again.

29. The filter apparatus of claim 12, wherein one housing part, which has one set of closure elements, is configured as a housing receptacle and serves to receive a filter element, and wherein the other housing part, which has the further closure elements, forms a housing cover for closing the housing receptacle so that it can be opened again.

30. The filter apparatus of claim 11, wherein the closure hooks, in pairs are arranged diametrically opposite one another in relation to the longitudinal axis of the filter housing, and arranged on the outer circumferential side in the edge region of the housing receptacle, protrude with their hook openings over the opening of the housing receptacle that can be released by the housing cover.
